(19) United States
(12) Patent Application Publication
(10) Pub. No.: US 2003/0028612 A1
(43) Pub. Date: Feb. 6, 2003

(54) System and method for providing mobile server services

(75) Inventors: Rui Lin, San Diego, CA (US); Gary Wang, San Diego, CA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 09/920,549

(22) Filed: Aug. 1, 2001

(51) Int. Cl. G06F 15/16

(52) U.S. Cl. 709/217

(57) ABSTRACT

Server services are provided by a mobile server having a master server portion and a virtual server portion. The master server portion resides in a wireless communication device and is responsible for the overall function of the mobile server and communicates with a data network through base stations and a support node that supports packet radio service communications. The virtual server portion is wireline coupled to the data network and acts as the foreground server responsible for client interactions on behalf of the mobile server. Accordingly, server services are available even when the wireless communication device is not available.

### FIELD OF THE INVENTION

This invention relates in general to the field of wireless communications, in particular to wireless and mobile servers and more particularly to wireless devices that provide server services.

### BACKGROUND OF THE INVENTION

Wireless data communication systems have been developed to free people from fixed wireline terminals without making it more difficult to reach them. However, servers, and particularly, Web servers, have not been able to take advantage of wireless communications because of reliability, availability and bandwidth limitations of wireless systems.

Servers are powerful computer systems that are connected to a network for providing server services. Servers, such as Web servers, are connected to data networks such as the internet or an intranet, and store documents and files such as audio, video, graphics or text, and can display these files to users accessing the server using, for example, the Hyper Text Transfer Protocol (HTTP). Web servers typically provide a Web site which responds to requests from remote clients running a Web browser. In other words, individual Web pages can be viewed and “visited” by a remote client device with a Web browser. A Web page is one of the many hypertext markup language (HTML) documents that make up a typical Web site.

The internet network utilizes the TCP/IP (Transmission Control Protocol/Internet Protocol) as a low level protocol used to implement the HTTP. The TCP/IP uses an IP address to locate and establish a session with another device on the network. For example, sessions may be established between client devices and servers on the network.

HTML provides basic document formatting and allows the developer to specify “links” to other servers and files. In the internet, a network path to a server is identified by a Uniform Resource Locator (URL) having a special syntax for defining a network connection. Use of an HTML-compatible browser at a client device involves specification of a link via the URL. When the user of the browser specifies a link, the client issues a request to map a hostname (in the URL) to a particular network IP address at which the server is located. The mapping request is delivered to a Domain Name System (DNS) server for mapping a DNS name to an IP address. Using the IP address, the browser establishes a connection to a server. If the server is available, it returns a document or other server data formatted according to HTML.

To help insure the availability and reliability of server services provided by a server, Web servers, for example, (including proxy servers) have been traditionally located at a fixed location and coupled to the network through high-bandwidth wireline connections that provide fast and reliable access to the server data. These wireline network connections also help insure full-time availability of the server.

There are, however, several disadvantages to this traditional server approach. For example, the server must be located at the fixed location to provide the server service and/or update server data. Another disadvantage to traditional server services is that the connection with the network must be very reliable and operational all the time to ensure availability of the server to client devices.

With the increased processing power and data storage capability of portable, handheld and wireless devices, it would be desirable to provide server services from such devices. This would allow server operators the freedom, for example, to operate a server service from anywhere and update server data anytime from anywhere. Portable, handheld and wireless devices have not been traditionally used for server services because the wireless connections with such devices typically fail to meet the reliability and availability that server services require. For example, wireless links are typically unreliable, and have inadequate bandwidth for fast data communications, and furthermore, because portable, handheld and wireless devices easily change their geographic location, the wireless connections to the network are not always available. Broadband wireless connections may be reliable enough and fast enough for server services, but they restrict the server to particular geographic locations and thus are not suitable for portable, handheld and wireless devices.

Thus what is needed is a method and apparatus for providing server service with a portable, handheld or wireless device. What is also needed is a method and apparatus that provides for improved reliability and improved availability for server services provided by portable, handheld and wireless devices.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a functional block diagram of a mobile server in accordance with an embodiment of the present invention;

FIG. 2 is a functional block diagram of a communication system in accordance with an embodiment of the present invention;

FIG. 3 illustrates a mobile server service registration process in accordance with an embodiment of the present invention;

FIG. 4 illustrates a communication and update procedure in accordance with an embodiment of the present invention; and

FIG. 5 illustrates a support node routing procedure in accordance with an embodiment of the present invention.

The description set out herein illustrates the various embodiments of the invention and such description is not intended to be construed as limiting in any manner.

### DETAILED DESCRIPTION

The present invention provides, among other things a method and apparatus that supports server service with a portable, handheld or wireless communication device. The present invention also provides a method and apparatus for improved server services by portable, handheld or wireless communication devices. The present invention also provides a mobile server and method of operating a mobile server suitable for use in portable, handheld and wireless communication devices.

In accordance with the various embodiments of the present invention, server services are provided by a mobile server having a master server portion and a virtual server portion. The master server portion may reside in a wireless communication device and is responsible for the overall function of the mobile server. The master server portion communicates with a data network through base stations and a support node that may support packet radio service communications. The virtual server portion may be wireline coupled to the data network and acts as the foreground server responsible for client interactions on behalf of the mobile server. Accordingly, reliable server services are available even when the wireless communication device is not available.

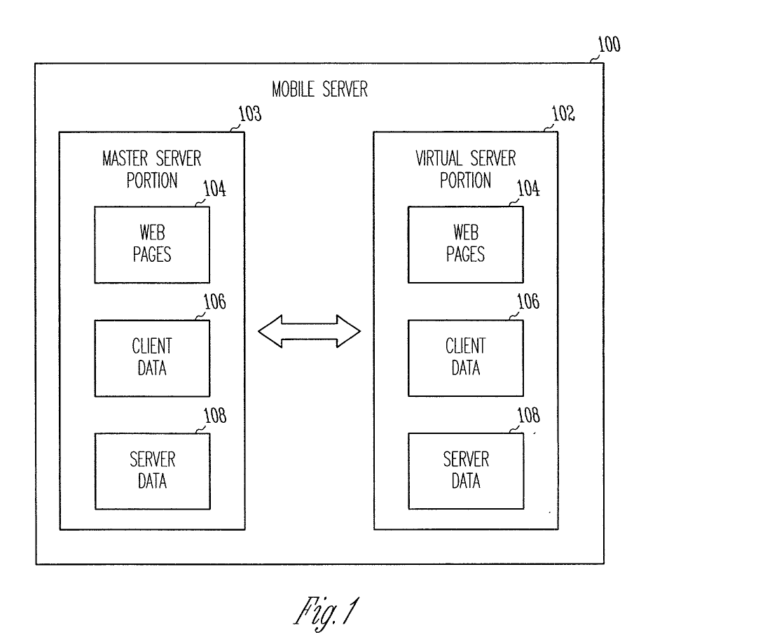

FIG. 1 is a functional block diagram of a mobile server in accordance with the present invention. Mobile server 100 is comprised of virtual server portion 102 and master server portion 103. Master server portion 103 and virtual server portion 102 are located at separate locations, with master server portion 103 being part of a mobile device that may regularly change locations. Master server portion 103 and virtual server portion 102 communicate with each other at various times as described herein. In general, master server portion 103 is responsible for the overall behavior of mobile server 100. Each portion of mobile server 100 includes hardware, software and data necessary to provide server services. Data may include Web pages 104, client data 106 and server data 108.

Master server portion 103, among other things, registers with support nodes of a wireless network to provide mobile server services, and may activate and deactivate such services. Master server portion 103 also uploads server data 108 to virtual server portion 102 and updates server data 108, and other data as required.

Virtual server portion 102, on the other hand, acts as the foreground server responsible for client interactions on behalf of mobile server 100. Virtual server portion 102 may initiate data synchronization with master server portion 103 when for example, client data 106 requires updating. In general, virtual server portion 102 maintains the same server data that is uploaded by master server portion 103. Through updates and synchronization, the portions attempt to maintain the same data with each other. For example, client data 106 may require updating as client devices are provided server services, or server data 108 may be updated by the user providing the server service. Accordingly, server services generated from virtual server portion 102 have a similar look and feel to server services that would be generated directly from master server portion 103.

Server services may include any service that may be provided to client devices by a remote server. Server services include, for example, offering email service and Web server services such as a Web site or Web pages which provide data to clients, gathers data from clients, or arrange for selling products or information to clients. Server services also may include database services that allow client devices query and update data on the mobile server. Server data stored in online databases may be exchanged and managed with other servers across the network. Data content may be registered user emails, address books, calendars, stock quotes, news, etc, and may be specific to users or user groups. Server services also include server processes that interact with client processes for setting up a connection, processing client requests, generating responses to client requests, and closing client connections. Rlogin and Telnet services may also be provided where users remotely login to the mobile server to access files and directories, download and upload files etc. Service services also include client session management services.

Although Web pages 104 are illustrated as a separate element of server portions 102 and 103, Web pages may be viewed as being a part of server data 108. In addition to Web pages 104, server data 108 may include, for example, other Web-site data. Client data 106 may include any data provided by a client or pertaining to a client. Data as used herein may take many different forms and may be any type of digital information including, for example, text data, pictures, audio data, and video data, and includes HTML files.

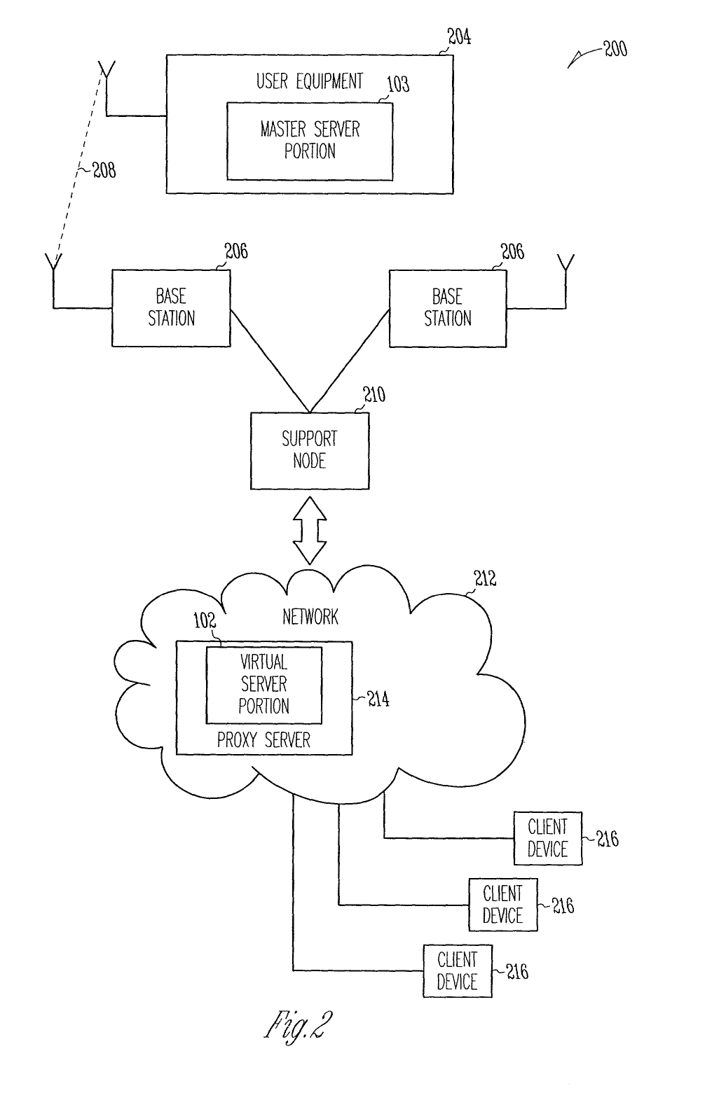

FIG. 2 is a functional block diagram of a communication system in accordance with an embodiment of the present invention. Communication system 200 may include user equipment 204 that communicates over wireless links 208 through base stations (BS) to support node 210 which is coupled to network 212. Network 212 couples to servers such as proxy server 214 and client devices 216. User equipment 204 may be a wireless communication device that provides a mobile server service in accordance with the various embodiments of the present invention. As discussed above, mobile server 100 (FIG. 1) is comprised of a separably located master server portion 103 and virtual server portion 102. User equipment 204 includes master server portion 103 along with other elements for communicating with base stations 206 over wireless links 208. In accordance with one embodiment, user equipment 204 may be a computing device, such as a mobile data terminal, with sufficient memory and processing power to support server service. User equipment 204 may be a portable or handheld computing device with the ability to communicate over wireless link 208. In addition to mobile server functionality, user equipment 204 may include functionality to operate as a wireless or cellular telephone, a smart phone, a personal digital assistant (PDA), a Web tablet, or any device that provides access to a network such as an intranet or the internet.

In accordance with the various embodiments of the present invention, wireless data communications between user equipment 204 and base stations 206 may support many digital mobile communication standards, such as the Pan-European mobile system standard referred to as the Global System for Mobile Communications (GSM). General Packet Radio Service (GPRS) is a packet data communication service suitable for use in a communication system such as a GSM system. User equipment 204 may include hardware, firmware and software to operate as a packet radio terminal for packet data service in accordance with a packet radio system standard such as the GPRS, although other digital communication systems, standards, and techniques for wireless data packet switched communications are equally applicable to the present invention. User equipment 204 may operate, including providing a server service, from any geographic location, even when communications with base station 206 are not possible.

Support Node 210 may be one of a plurality of data service support nodes that provide an interface between a packet radio type of system and other communication systems and networks. Support node 210 provides mobile data terminals, such as user equipment 204, with a communication service such as a packet data service through one of the several base stations 206. Preferably, support node 210 is a “Servicing GPRS Support Node” (SGSN) which is coupled to a mobile network portion of network 212. The mobile network portion may be a GSM type wireless or mobile network that provides packet switched communications for mobile terminals such as user equipment 204. Network 212 also includes a data network portion coupled with the mobile network portion. The data network portion may be any network suitable for data communications including the internet, the public switched telephone network (PSTN), and private as well as public intranets. Accordingly, packet data communications are provided between user equipment 204 and network 212.

Network 212 provides for data communications among client devices 216, various servers located on network 212, and user equipment 204 as described above. Client devices 216 typically include computing devices such as servers and personal computers that communicate over network 212; however client devices may also include portable, handheld and wireless communication devices configured to communicate with a data network portion of network 212.

Virtual server portion 102 is desirably a stand-alone server coupled to network 212; however mobile virtual server may also functionally be part of a proxy server such as proxy server 214 coupled to network 212. Regardless of whether virtual server portion 102 is part of proxy server 214, in an example embodiment of the present invention, proxy server 214 provides a proxy server function for mobile server 100. Proxy server 214 may use different ports for servicing external requests and for internal synchronization with master server portion 103. Through the use of different ports, proxy server 214 may enforce different authentication and security policies with master server portion 103 to ensure, for example, that master server portion is not infected with a virus and that communications are authentic.

In accordance with the various embodiments of the present invention, a user may desire to provide server service using user equipment 204. For such server services, client communications (including client requests for server services) are directed to the mobile server. A support node routes these communications to virtual server portion 102, which handles such client requests and communications on behalf of master server portion 103. For example, client device 216 may request server service for access to a Web page or Web site provided by mobile server 100. Accordingly, the server service provided by user equipment 204 through virtual server portion 102 is available to handle client requests even though user equipment 204 is unavailable (e.g., out of base station range, turned off, etc.).

In one embodiment of the present invention, master server portion 103 and virtual server portion 102 may be configured to operate in accordance with the standard Telnet protocol, or alternatively, the Rlogin terminal interface between UNIX hosts using the TCP/IP network protocol for when the remote host behaves like a UNIX machine. In another embodiment of the present invention, master server portion 103 and virtual server portion 102 may be configured in accordance with the Universal Mobile Telephone System (UMTS) for the next generation of GSM which implements the International Mobile Telecommunications for the year 2000 (IMT-2000) family of third-generation (3G) wireless standards. Support node 210 may provide an inter-networking interface function (IWF) in such networks.

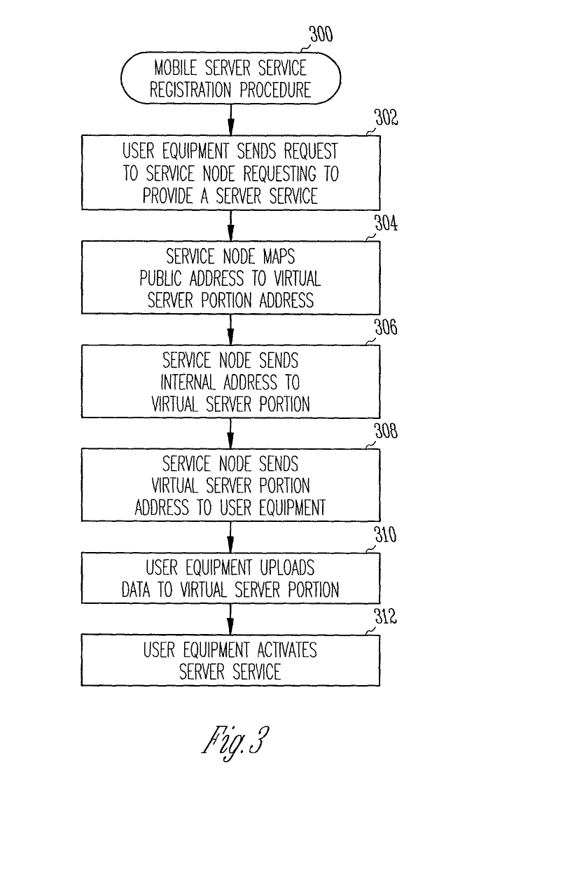

FIG. 3 illustrates a mobile server service registration procedure in accordance with an embodiment of the present invention. Registration procedure 300 may be implemented when mobile server 100 (FIG. 1) desires to register with a service provider to provide mobile server services. Service providers, for example, may include organizations that provides network services or grant network connectivity, and include service providers that provide internet connectivity and services, wireless communication and data services, telephone services, etc. In task 302, a request for mobile server service is received from user terminal 204. The request may be received at a support node such as support node 210 from a wireless communication device such as user terminal 204 through wireless portions of network. For example, user equipment 204 may send the request over link 208 to support node 210 through a wireless network including base stations 206. The request preferably includes a public network address, such as the IP address or domain name for the user equipment or the user's server service.

In task 304, a service provider associated with support node 210 determines whether or not to grant the mobile user the request for server service. The service provider may require user credit verification and other information from user equipment 204. As part of task 304, user equipment 204 may be assigned its public network address if it does not already have one, as well as a private/internal network address for its mobile server service. When the request is granted, support node 210 sets up a process that maps the public network address of user equipment 204 to an address of a virtual server that will act as virtual server portion 102 of mobile server 100.

In task 306, support node 210 sends the private/internal address of user equipment 204 to virtual server portion 102, and support node 210 directs virtual server portion 102 to operate as a virtual server for the server service provided by mobile server 100.

In task 308, support node 210 notifies user equipment 204 that its request for mobile server service has been granted and sends the network address of virtual server portion 102 to user equipment 204. In task 310, user equipment 204 uploads (e.g., transfers) server data to virtual server portion 102, including Web pages and Web-page content and any associated client or server data. The uploaded data desirably includes all data necessary for virtual server portion 102 to provide server service on behalf of mobile server 100. In this way, server service is available even when master server portion 103 is not. In task 310, user equipment 204 uses the network address of virtual server portion 102 that was provided in task 308.

When a user of user equipment 204 decides to active its approved mobile server service, user equipment 204 sends an activation request to support node 210. In task 312, support node 210 receives the request to activate a mobile server service from user equipment 204. In response, support node 210 activates the server service that is provided by user equipment 204 through the master and virtual server portions of mobile server 100. Subsequent to activation of the server service, the processes below may be implemented by support node 210 and various other elements of system 200. The user of user equipment 204 may also decide to deactivate its activated mobile server service by sending a deactivation request to support node 210, which de-activates the server service.

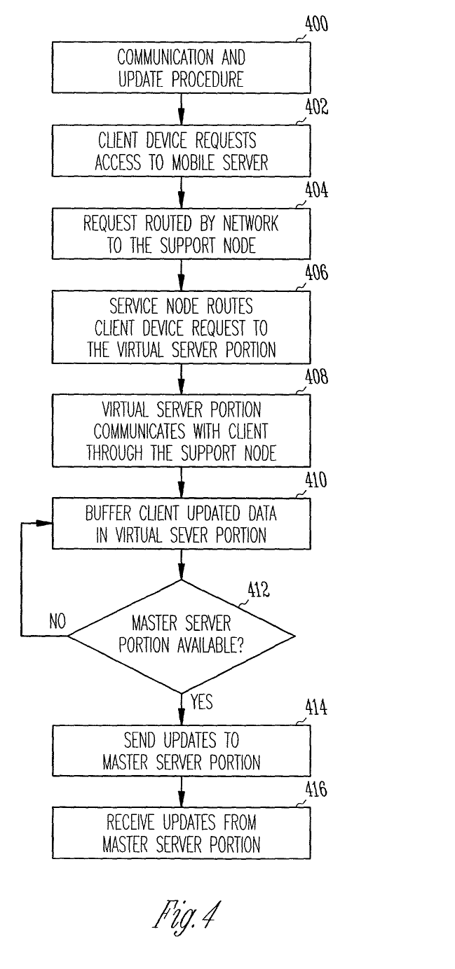

FIG. 4 illustrates a communication and update procedure in accordance with an embodiment of the present invention. Procedure 400 is implemented once a user's mobile server service has been activated. In task 402, a client device requests server service from mobile server 100. Task 402, for example, may include client device 216 requesting access to a Web page or Web site provided by mobile server 100. The request may be in accordance with an internet protocol such as TCP/IP and includes the public network address of mobile server 100.

In task 404, the request is routed to support node 210. Wireless data communication devices such as user equipment 204 that are located in a mobile network are serviced through support nodes, such as support node 210. These wireless data communication devices may have public network (IP) addresses that are associated with the support nodes that support the system. This causes network 212 to route packets directed to any one of these wireless data communication devices to the support nodes. The public network address of mobile server 100 is accordingly associated with support node 210. In task 406 after the client request is received by support node 210, the client request is routed by support node 210 to virtual server portion 102 using the virtual server portion's network address.

In task 408, support node 210 may support the server service by routing communications between virtual server portion 102 and the client device being serviced. For example, when a client device is accessing a Web page provided by mobile server 100, data packets are communicated between one of client devices 216 and support node 210, and between support node 210 and virtual server portion 102. Client devices 216 are unaware that virtual server portion 102 is providing the server service on behalf of master server portion 103. Accordingly, mobile server service is provided even when user equipment 204 is unable to communicate with base station 206. During the providing of server service, client data may require updating. In this case, virtual server portion 102 buffers this client data, as part of task 410, until it is able to provide it to master server portion 103, for example, when master server portion 103 is available through the wireless network.

In task 412, virtual server portion 102 determines if master server portion 103 is available. For example, virtual server portion 102 may send a request to update client data to support node 210 using the internal/private network address of mobile server 100. Support node 200 knows when user equipment 204 is available and will inform virtual server portion 102 accordingly. When user equipment 204 is available, virtual server portion 102 sends updated client data to master server portion 103 in user equipment 204 as part of task 414. In task 416, user equipment 204 updates the client data on master server portion 103.

When user equipment 204 is determined to be not available in task 412, virtual server portion 102 may maintain the buffered client data until user equipment 204 becomes available. In one embodiment of the present invention, support node 210 may notify virtual server portion 102 when user equipment 204 is available. In another embodiment, virtual server portion 102 may query support node 210 regularly to determine when user equipment 204 is available. Because user equipment 204 may be located at any geographic location, updates may occur automatically when a base station is available to user equipment 204 for communicating.

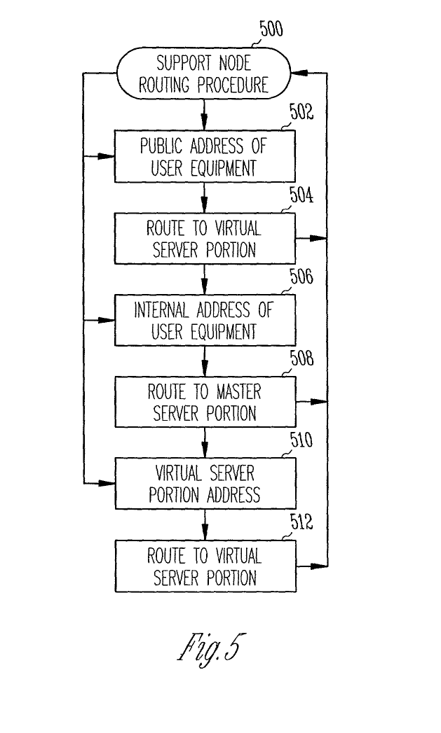

FIG. 5 illustrates a support node routing procedure in accordance with an embodiment of the present invention. Procedure 500 is performed by a support node, such as support node 210, after mobile server service is activated for particular user equipment 204, for example, in accordance with procedure 300 (FIG. 3). In task 502, when support node 210 receives communications directed to the public address mobile server 100, support node 210 routes these communications to virtual server portion 102 in task 504. Communications may include typical TCP/IP communications from a client device's Web browser accessing the server service (e.g., Web pages, Web-site data) supported by mobile server 100. Support node 210 does not have to convert these communications to GPRS format, since it does not have to route such communications to base stations 206 to user equipment 204.

In task 506, support node 210 receives communications that may include updated client or server data from virtual server portion 102 which are directed to the internal network address of mobile server 100. In task 508, support node 210 routes these communications to master server portion 103 through base stations 206. In this situation, support node converts the data packets to a packet radio data format, such as GPRS format, for receipt by user equipment 204. In accordance with the various embodiments of the present invention, virtual server portion 102 will send updated data only when user equipment 204 is available, and accordingly, task 508 will only be performed when user equipment 204 is available. Desirably, the updated client or server data is buffered in virtual server portion 102 and provided to support node 210 in task 506 in a batched manner.

In task 510, support node 210 receives communications addressed to virtual server portion 102. These communications may be received from master server portion 103 through the wireless network. In task 512, support node 210 routes these communications to virtual server portion 102 using the network address of virtual server portion 102. As part of task 512, support node 210 converts these communications from a packet radio data format to a network format such as TCP/IP. The communications received in task 510 may comprise server data updates which are desirably initiated automatically by master server portion 103 when user equipment 204 has a connection with base station 206.

Thus, a method and apparatus that supports server service with a portable, handheld or wireless communication device has been described. The method and apparatus allows portable, handheld or wireless communication device to provide improved server services. A mobile server and method of operating a mobile server suitable for use in portable, handheld and wireless devices has been. The improvements over known technology are significant.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A mobile server comprising:
a master server portion to communicate server data wirelessly; and
a virtual server portion coupled to the master server portion through a support node to communicate the server data and service a client request via wireline.

2. The mobile server as claimed in claim 1 wherein:
the master server portion is part of a wireless communication device that communicates through base stations to the support node coupled with a data network, and
the virtual server portion is wireline coupled with the data network.

3. The mobile server as claimed in claim 2 wherein the support node to receive the client request from a client device over the data network addressed to the mobile server, and the support node to route the client request to the virtual server portion to service the client request.

4. A mobile server as claimed in claim 3 wherein the wireless communication device to communicate in accordance with a packet radio service communication format and the service node to convert data packets between the packet radio service communication format of a wireless communication system and a data packet format of the data network.

5. The mobile server as claimed in claim 2 wherein the master server portion and the virtual server portion each comprise:
Web-page data;
client data; and
server data,
wherein when the wireless communication device is in communication with one of the base stations, the support node to provide an update to the client data in the master server portion, the update buffered the virtual server portion.

6. The mobile server as claimed in claim 5 wherein when the wireless communication device is in communication with one of the base stations, the master server portion to provide an update to the server data and the Web-page data of the virtual server portion.

7. The mobile server as claimed in claim 5 wherein the virtual server portion to provide the Web-page data to client devices over the data network using an internet communication protocol in response to the client requests both when the wireless communication device is in communication with one of the base stations and when the wireless communication device is not in communication with one of the base stations.

8. The mobile server as claimed in claim 1 wherein the mobile server has a private network address and a public network address associated therewith, and wherein:
the support node to route data packets that have the public network address as a destination address to the virtual server portion;
the support node to route data packets that have the private network address as a destination address to the master server portion; and
the support node to route data packets that have a network address of the virtual server portion to the virtual server portion.

9. The mobile server as claimed in claim 8 wherein:
the data packets having the public address as the destination address comprise the client request,
the data packets having the private network address as the destination address comprise updates to client data from the virtual server portion intended for the master server portion, and
the data packets having the network address of the virtual server portion comprise updates to server data from the master server portion intended for the virtual server portion.

10. A system that provides mobile server service comprising:
a mobile server to service client requests, the mobile server comprising a virtual server portion to operate in a wireline data network and a master server portion to operate in a wireless communication system; and
a support node to route client requests received through the wireline data network to the virtual server portion for servicing, and to convert data packets between a wireless packet radio format of the wireless communication system and a wireline data network format of the wireline data network.

11. The system as claimed in claim 10 wherein the mobile server comprises client data and server data, the master server portion to update the server data on the virtual server portion when the master server portion is in communication with the wireless communication system, the virtual server portion to update the client data on the master server portion when the master server portion is in communication with the wireless communication system.

12. The system as claimed in claim 11 wherein the virtual server portion to buffer updated client data until the master server portion is in communication with the wireless communication system.

13. The system as claimed in claim 11 wherein the server data comprises a Web page, the virtual server portion to provide the Web page to a client device in response to a client request over the wireline data network.

14. A method for providing mobile server services from a wireless communication device comprising:
receiving server data for a virtual server portion of a mobile server from a master server portion of the mobile server through a wireless network;
routing a client request for server service to the virtual server portion; and
servicing the client request by the virtual server portion providing at least some of the server data,
wherein the master server portion resides in the wireless communication device and communicates the server data wirelessly, and the virtual server portion is coupled via wireline to a data network

15. The method as claimed in claim 14 further comprising receiving the client request through the data network, and wherein the virtual server portion resides in a fixed location.

16. The method as claimed in claim 15 further comprising:
receiving the client request at a support node, the support node providing an interface between the wireless network and the data network, the wireless network supporting wireless packet radio communications; and
communicating the server data through the wireless network from the wireless communication device to the support node.

17. The method as claimed in claim 16 further comprising:
receiving, at the support node, the client request comprising data packets addressed to the mobile server;
identifying the client request by the support node as being directed to the mobile server; and
routing, by the support node, the client request to the virtual server portion over the data network.

18. The method as claimed in claim 14 wherein the servicing comprises providing a Web page to a client device.

19. The method as claimed in claim 18 wherein the servicing further comprises allowing the client device access to Web-site data stored on the virtual server portion.

20. The method as claimed in claim 15 further comprising receiving the client request directed to the mobile server at a support node supporting wireless packet radio communications with the wireless communication device.

21. The method as claimed in claim 14 wherein the client request comprises data packets in accordance with an internet communication protocol.

22. The method as claimed in claim 21 wherein the client request comprises a request using a hypertext transmission protocol and is a request from a Web browser operating on the client device to transfer a hypertext markup language file to the client device from the mobile server.

23. The method as claimed in claim 14 further comprising buffering updated client data in the virtual server portion until the master server portion is available to receive the updated client data.

24. The method as claimed in claim 23 wherein the virtual server portion addresses data packets that comprise the updated client data to a private network address of the mobile server, the support node recognizing the private address and routing the data packets to the master server portion over the wireless network.

25. The method as claimed in claim 24 wherein routing the data packets that comprise the updated client data further comprises converting the data packets from a data network format to a wireless packet radio communication system format.

26. The method as claimed in claim 14 wherein the mobile server has a private network address and a public network address associated therewith, and wherein the method further comprises a support node:
routing data packets that have the public network address as a destination address to the virtual server portion;
routing data packets that have the private network address as a destination address to the master server portion; and
routing data packets that have a network address of the virtual server portion to the virtual server portion.

27. The method as claimed in claim 16 wherein:
the data packets having the public address as the destination address comprise the client request,
the data packets having the private network address as the destination address comprise updates to client data from the virtual server portion intended for the master server portion, and
the data packets having the network address of the virtual server portion comprise updates to server data from the master server portion intended for the virtual server portion.

28. A method of operating a server having a master server portion residing in a wireless communication device and a virtual server portion coupled via wireline to a data network, the method comprising:
registering with a support node to provide server services, the support node providing an interface between a wireless network and a data network supporting packet radio data communications for the wireless communication device over the wireless network;
transmitting server data to the support node over the wireless network for routing to the virtual server portion over the data network; and
receiving client data updates from the support node over the wireless network, the client data updates being routed to the support node from the virtual server portion over the data network,
wherein requests for server services are provided by the virtual server portion when the master server portion is unavailable.

29. The method as claimed in claim 28 wherein the server has a private network address and a public network address associated therewith, and wherein the method further comprises the wireless communication device transmitting a request to activate the server services, and in response to an activation, the support node routes data packets received from client devices that have the public network address as a destination address to the virtual server portion.

30. The method as claimed in claim 29 wherein in response to the activation, the support node routes data packets from the virtual server portion that have the private network address as a destination address to the master server portion, and routes data packets from the master server portion that have a network address of the virtual server portion to the virtual server portion.
